(19) United States
(12) Patent Application Publication
(10) Pub. No.: US 2014/0144504 A1
(43) Pub. Date: May 29, 2014

(54) UV CURABLE SEALING COMPOSITION AND DYE-SENSITIZED SOLAR CELL USING THE SAME

(71) Applicant: Hyundai Motor Company, Seoul (KR)

(72) Inventors: Yong Jun Jang, Seongnam (KR); Sol Kim, Seoul (KR); Sang Hak Kim, Gunpo (KR); Ki Chun Lee, Seoul (KR); In Woo Song, Yongin (KR)

(73) Assignee: HYUNDAI MOTOR COMPANY, Seoul (KR)

(21) Appl. No.: 13/902,000

(22) Filed: May 24, 2013

(30) Foreign Application Priority Data
Nov. 23, 2012 (KR) 10-2012-0133876

(51) Int. Cl. H01G 9/20

(52) U.S. Cl. CPC H01G 9/2077
USPC 136/259; 524/560; 522/178; 522/18

(57) ABSTRACT

Disclosed is a UV curable sealing composition for a dye-sensitized solar cell. The UV curable sealing composition includes a polymer bead as a spacer for maintaining an interval between electrodes of the dye-sensitized solar cell.

### CROSS-REFERENCE TO RELATED APPLICATION

This application claims under 35 U.S.C. §119(a) the benefit of Korean Patent Application No. 10-2012-0133876 filed Nov. 23, 2012, the entire contents of which are incorporated herein by reference.

### BACKGROUND

(a) Technical Field

The present invention relates to a UV curable sealing composition and a dye-sensitized solar cell using the UV curable sealing composition. More particularly, the present invention relates to a UV curable sealing composition that improves the long-term durability of a solar cell and a dye-sensitized solar cell for a vehicle using the UV curable sealing composition.

(b) Background Art

In light of growing concerns on the global warming, technologies for utilizing eco-friendly energy have been receiving a lot of attention. A primary interest among these technologies is the solar cell field which involves the utilization of new recyclable energy. Examples of solar cells include silicon-based solar cells, thin film solar cells using inorganic substances such as copper indium gallium selenide (Cu(InGa)Se₂; CIGS), dye-sensitized solar cells, organic solar cells, and organic and inorganic hybrid solar cells. Among these, dye-sensitized solar cells have received much attention in the portable electronic industry field as well as in the Building Integrated Photovoltaic System (BIPV) industry field due to their low price and high efficiencies which allows for commercialization.

Dye-sensitized solar cells, unlike other solar cells, have a solar cell system that absorbs visible light to produce electricity by a photoelectric conversion mechanism. Generally, the dye-sensitized solar cells use a liquid electrolyte or gel electrolyte. However, the liquid and gel electrolytes may leak if the solar cell substrate is damaged. Such leakage may not only reduce the marketability of dye-sensitized solar cells, but may also damage the health of consumers due to the harmfulness of the electrolyte used.

For this reason, interest in the development of sealing agents has recently increased. As sealing agents for solar cells, a thermosetting polymer film from Du Pont Inc. or a thermal curing glass frit is being widely used. While the polymer film can be easily used in connection with the solar cell modules, it has a fatal claw in that it lacks sufficient long-term durability. The glass frit has a disadvantage in that, due to the formation of pores after curing, the liquid electrolyte is capable of penetrating therethrough, which can lead to corrosion of the silver grid (i.e. a portion of the solar cell). Since a vehicle durability test is more difficult to pass than a general solar cell module test, there is an urgent need for the development of a new sealing agent suitable for use in a vehicle.

Korean Patent No. 1109175 describes an ultraviolet curing resin composition containing a photopolymerization initiator in addition to chlorinated polyolefin, monometha(acrylate), polypropylene glycol dimetha(acrylate), and dimetha(acrylate), and a sealing agent including the composition as an active ingredient. However, this technology has a limitation in that the thickness between electrodes is not adequately controlled.

Korean Patent No. 1081497 describes a sealant for an ECM that is formed of an ultraviolet curing resin composition including aliphatic urethane acrylate oligomer, metha(acrylate) monomer, silane compound, and photoinitiator. However, this technology has a limitation in that the ultraviolet curing resin composition is not formed in a bead-type and it contains a silane compound.

Korean Patent Application Publication No. 2005-0029612 describes an ultraviolet curing sealant containing an acryl resin and a photoinitiator in addition to an epoxy resin and an initiator. However, this technology has a limitation in that it contains an epoxy resin as a thermosetting resin in addition to the acryl resin.

Japanese Patent No. 4884824 describes an ultraviolet curing hotmelt-type sealing material that includes a cationic polymerization-type UV curing component, a radical polymerization-type UV curing component, an adhesive resin, and a thermoplastic elastomer. The radical polymerization-type UV curing component has an UV curing component at both ends thereof and the ultraviolet curing hotmelt-type sealing material is mixed with an ultraviolet polymerization initiator. However, this technology is carried out such that the sealing material is coated in a molten state in the presence of an inert gas.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a UV curable sealing composition that improves the long-term durability of a solar cell, and further provides a dye-sensitized solar cell for a vehicle using the UV curable sealing composition.

According to one aspect, the present invention provides a UV curable sealing composition containing micro-sized particles and a dye-sensitized solar cell using the UV curable sealing composition. The micro-sized particles are also referred to herein as a “spacer”. According to various embodiments, the UV curable sealing composition is capable of maintaining a uniform interval between an ultraviolet photocurable material and a module electrode. According to the present invention, the curing of the UV curable sealing composition provides a nonporous composition and, thus, electrolyte penetration is difficult. As such, the UV curable sealing composition of the present invention can prevent corrosion of the silver grid. Also, since the UV curable sealing composition is capable of maintaining an interval between electrodes by using micro-sized particles, the potential for a short-circuit between the electrodes can be reduced or eliminated.

The object of the present invention is to improve the long-term durability of a dye-sensitized solar cell module that uses a liquid electrolyte. Generally, a liquid electrolyte inside a solar cell may leak out of the module when a typical polymer film- or glass frit-type sealing agent is used, causing reduction of the current density and the efficiency of the solar cell. This reduces the lifespan and makes commercialization more challenging.

According to embodiments of the present invention, since the thickness of the module is uniformly maintained by applying micro-particles in the UV curable sealing composition, durability of the solar cell for use in a vehicle can be achieved.

According to the present invention, a UV curable sealing composition, a dye-sensitized solar cell using the UV curable sealing composition, and a method for manufacturing the dye-sensitized solar cell using the UV curable sealing composition are provided. According to the present invention, a UV curable sealing composition suitable for sealing a solar cell is provided which controls the thickness of the counter electrode and the photoelectrode of the solar cell and has excellent physical properties compared to a typical polymer film-type sealing agent. The present invention further provides an optical film manufactured using the UV curable sealing composition. In contrast with conventional polymer sealing agents which present a difficulty in controlling thickness the sealing composition of the present invention can easily control thickness according to the diameter and the content of the micro-polymer beads (spacer), and can consistently meet long-term durability testing. The UV curable sealing composition according to an embodiment of the present invention includes one or more monomer resins (e.g., acryl resin), photoinitiator, and polymer micro-sized particles.

A monomer resin of a UV curable sealing composition according to an embodiment of the present invention may include one or more monomer selected from the group consisting of vinyl monomer, lauryl metha(acrylate), stearyl metha(acrylate), butoxyethyl metha(acrylate), ethoxydiethylene glycol metha(acrylate), methoxytriethylene glycol metha(acrylate), methoxypolyethylene glycol metha(acrylate), methoxydipropylene glycol metha(acrylate), and cyclohexyl metha(acrylate).

According to various embodiments, the content of the monomer resin of the UV curable sealing composition ranges from about 10 wt % to about 89wt %, more preferably about 80 wt % to about 89 wt % (e.g. about 80 to 89 wt % in an exemplary embodiment), relative to the total weight of the UV curable sealing composition . When the content of the monomer resin is less than about 10 wt %, the crosslinking degree of a resulting film becomes too high to control the physical properties of a film being manufactured therefrom. In contrast, when the content of the monomer resin exceeds about 89 wt % it is difficult to control the curability of a film, which makes it difficult to manufacture a film for solar cell module sealing composition.

According to various embodiments, the weight-average molecular weight of the monomer resin ranges from about 1,000 to about 20,000 g/mol. When the weight-average molecular weight of the monomer resin is smaller than about 1,000, it is difficult to form a film. When the weight-average molecular weight of the monomer resin exceeds about 20,000, the physical properties of the film may be deteriorated.

According to various embodiments, the content of the photopolymerization initiator ranges from about 1.0 wt % to about 10 wt % relative to the total weight of the UV curable sealing composition. In an exemplary embodiment, the photopolymerization initiator includes a mixture of 1-hydroxy-cyclohexyl phenyl ketone, methyl benzoylformate, 2,4,6-trimethyl benzoyldiphenyl-phosphine oxide, bis (2,4,6-trimethyl benzoyl)-phenylphosphine oxide, 2-hydroxy-1-{4-[4-(2-hydroxy-2-methyl-propionyl)-benzyl]-phenyl}-2-methyl-propane-1-on, and oligo[2-hydroxy-2-methyl-1-[4(1-methyl vinyl)phenyl]propane]. The various components of the photopolymerization initiator may be used independently or as a mixture. When the content of the photopolymerization initiator is smaller than about 1.0 wt %, photocuring may not occur, making it difficult to form a pattern due to the tackiness thereof. Also, when the content of the photopolymerization initiator is greater than about 10 wt %, while the photocuring of the resin composition may quickly progress, a resin component of a low molecular weight may be formed as a by-product, negatively affecting the physical properties of the final cured product. Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view illustrating a dye-sensitized solar cell manufactured using a sealing composition including a spacer (i.e., micro-sized particles) according to an exemplary embodiment of the present invention; and

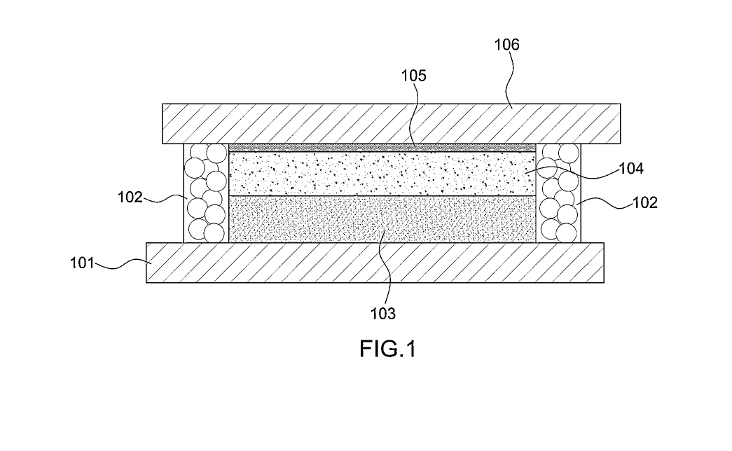

FIG. 2 is an optical microscopic photograph illustrating a polymer bead spacer included in a sealing composition according to an embodiment of the present invention.

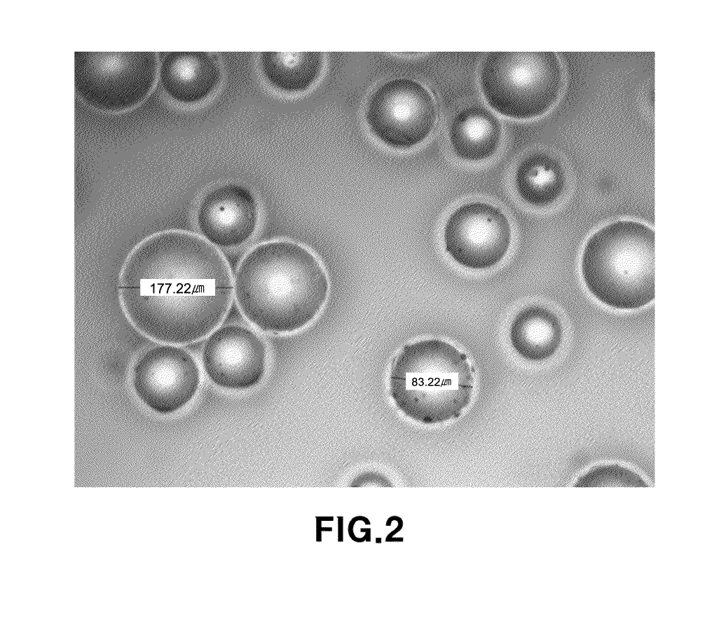

Reference numerals set forth in the Drawings includes reference to the following elements as further discussed below:

101: first substrate

102: UV curable composition with spacer

103: inorganic oxide layer

104: electrolyte layer

105: counter electrode layer

106: second substrate

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The above and other features of the invention are discussed infra.

Hereinafter, a process of manufacturing a dye-sensitized solar cell manufactured according to an exemplary embodiment of the present invention will be described.

Manufacture Example: manufacture of an ultraviolet curing agent with spacer

In order to manufacture an ultraviolet curing agent, a UV curable monomer of about 80 wt %, a UV curable cross-linking agent of about 10 wt %, and an initiator of about 1 wt % were stirred in a UV-blocking glass reactor for about one hour. Then, a (poly(methyl metha(acrylate)) (PMMA)) bead of about 9 wt %, which serves as a spacer, was added in the mixture and stirred.

### EXAMPLES 1 to 3

### Manufacture of a Solar Cell Including the Ultraviolet Curing Agent With Spacer Manufactured From the Manufacture Example

Titanium dioxide paste (Solaronix Inc.) for screen printing was coated on a glass substrate coated with fluorine-doped tin oxide (FTO) using a screen printing machine. The glass substrate was heated at a temperature of about 300° C. for about one hour, and then fired at a temperature of about 500° C. for about three hours. A dye (N3 from Solaronix Inc.) was adsorbed onto the manufactured electrode at room temperature for about 24 hours. An ultraviolet curing agent with the spacer (as manufactured according to the Manufacture Example) was coated on the outer edge of the photoelectrode with a TIO₂ coating layer absorbed with the dye, and then a platinum counter electrode substrate was put thereon to perform hardening using an ultraviolet curing machine. Electrolyte (AN50 from Solaronix Inc.) was injected, and then the injection inlet was sealed with the same ultraviolet curing.

### COMPARATIVE MANUFACTURE EXAMPLE

### Manufacture of an Ultraviolet Curing Agent Without Spacer

In order to manufacture an ultraviolet curing agent, a UV curable monomer of about 89 wt %, a UV curable cross-linking agent of about 10 wt %, and an initiator of about 1 wt % were stirred in a UV-blocking glass reactor for about one hour.

### COMPARATIVE EXAMPLES 1 to 3

### Manufacture of a Solar Cell Including the Ultraviolet Curing Agent Without Spacer Manufactured From the Comparative Manufacture Example

Titanium dioxide paste (Solaronix Inc.) for screen printing was coated on a glass substrate coated with fluorine-doped tin oxide (FTO) using a screen printing machine. The glass substrate was heated at a temperature of about 300° C. for about one hour, and then fired at a temperature of about 500° C. for about three hours. A dye (N3 from Solaronix Inc.) was adsorbed onto the manufactured electrode at room temperature for about 24 hours. An ultraviolet curing agent (as manufactured according to the Comparative Manufacture Example) was coated on the outer edge of the photoelectrode with a TIO₂ coating layer absorbed with the dye, and then a platinum counter electrode substrate was put thereon to perform hardening using an ultraviolet curing machine. Electrolyte (AN50 from Solaronix Inc.) was injected, and then the injection inlet was sealed with the same ultraviolet curing.

The thickness and efficiency of dye-sensitized solar cells manufactured by the Examples 1 to 3 and the Comparative Examples 1 to 3 are shown in Table 1 below. The solar cells which were provided with the spacer in accordance with the present invention demonstrated a relatively uniform thickness, whereas the solar cells without the spacer demonstrated inconsistent thicknesses between electrodes. The photoelectric conversion efficiency confirmed that this uniformity acts as a factor affecting the efficiency.

TABLE 1

| | Thickness of Solar Cell | Energy Conversion |
|---|---|---|
| Sample | (μm) | Efficiency (%) |
| Example 1 | 100 | 3.5 |
| Example 2 | 105 | 3.4 |
| Example 3 | 98 | 3.5 |
| Comparative Example 1 | 50 | 4.1 |
| Comparative Example 2 | 150 | 2.5 |
| Comparative Example 3 | 200 | 2.3 |

A UV curable sealing composition including a spacer in accordance with the present invention provides the following advantages. The spacer can maintain a uniform gap between a counter electrode and a photoelectrode, which can prevent a short-circuit. Further, the spacer can maintain the thickness of a solar cell module, and enables the manufacture of a solar cell having uniform current and voltage. By enabling the manufacture a solar cell panel that secures a uniform current, the electric power necessary for each vehicle can be more accurately predicted.

In a dye-sensitized solar cell according to an embodiment of the present invention, a sealing composition including a spacer is provided which can prevent solvent leakage of liquid electrolyte and can maintain a uniform interval between upper and lower electrodes. As a result, short-circuiting of the solar cell can be prevented and long-term durability thereof is improved.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A UV curable sealing composition for a dye-sensitized solar cell comprising:
a plurality of polymer beads as a spacer for maintaining an interval between electrodes of the dye-sensitized solar cell.

2. The UV curable sealing composition of claim 1, wherein the at least one polymer bead comprises an acryl-based polymer having a particle size of about 10 μm to about 1,000 μm.

3. The UV curable sealing composition of claim 1, wherein the at least one polymer bead is included in the UV curable sealing composition from about 1 wt % to about 10 wt % relative to the total weight of the UV curable sealing composition.

4. The UV curable sealing composition of claim 1, further comprising
at least one monomer resin selected from the group consisting of vinyl monomer, lauryl metha(acrylate), stearyl metha(acrylate), butoxyethyl metha(acrylate), ethoxydiethylene glycol metha(acrylate), methoxytriethylene glycol metha(acrylate), methoxypolyethylene glycol metha(acrylate), methoxydipropylene glycol metha(acrylate), and cyclohexyl metha(acrylate),
wherein the monomer resin is included in the UV curable sealing composition from about 80 wt % to about 89 wt % relative to the total weight of the UV curable sealing composition.

5. The UV curable sealing composition of claim 1 further comprising a photopolymerization initiator,
wherein the photopolymerization initiator is included in the UV curable sealing composition from about 1 wt % to about 10 wt % relative to the total weight of the UV curable sealing composition.

6. A dye-sensitized solar cell including the sealing composition according to claim

7. The dye-sensitized solar cell of claim 6, wherein the UV curable sealing composition has a thickness of about 10 μm to about 100 μm.

8. A UV curable sealing composition for a dye-sensitized solar cell comprising at least one monomer resin, at least one photoinitiator, and polymer micro-sized particles.

9. The UV curable sealing composition of claim 8, wherein the at least one monomer resin is selected from the group consisting of vinyl monomer, lauryl metha(acrylate), stearyl metha(acrylate), butoxyethyl metha(acrylate), ethoxydiethylene glycol metha(acrylate), methoxytriethylene glycol metha(acrylate), methoxypolyethylene glycol metha(acrylate), methoxydipropylene glycol metha(acrylate), and cyclohexyl metha(acrylate),

10. The UV curable sealing composition of claim 8, wherein the at least one monomer resin is included in the UV curable sealing composition from about 80 wt % to about 89 wt % relative to the total weight of the UV curable sealing composition.

11. The UV curable sealing composition of claim 8, wherein the at least one photoinitiator is a mixture of 1-hydroxy-cyclohexyl phenyl ketone, methyl benzoylformate, 2,4,6-trimethyl benzoyldiphenyl-phosphine oxide, bis (2,4,6-trimethyl benzoyl)-phenylphosphine oxide, 2-hydroxy-1-{4-[4-(2-hydroxy-2-methyl-propionyl)-benzyl]-phenyl}-2-methyl-propane-1-on, and oligo[2-hydroxy-2-methyl-1-[4(1-methyl vinyl)phenyl]propane].

12. The UV curable sealing composition of claim 8, wherein the at least one photoinitiator is included in the UV curable sealing composition from about 1.0 wt % to about 10 wt % relative to the total weight of the UV curable sealing composition.
